(19) United States
(12) Patent Application Publication
(10) Pub. No.: US 2010/0215910 A1
(43) Pub. Date: Aug. 26, 2010

(54) PROFILED PLASTIC PIECE THAT CAN BE DECORATED, AND METHOD FOR THE PRODUCTION THEREOF

(76) Inventors: Sven Kühnberger, Selbitz (DE); Oliver Hagen, Hof (DE)

Correspondence Address: MOETTELI & ASSOCIATES SARL, ST. LEONHARDSTRASSE 4, ST. GALLEN, CH-9000, CH

(21) Appl. No.: 12/524,598

(22) PCT Filed: Jan. 23, 2008
(86) PCT No.: PCT/EP2008/000492

§ 371 Date: Jul. 28, 2009

(30) Foreign Application Priority Data
Jan. 27, 2007 (DE) 10 2007 004 229.0

(51) Int. Cl. B32B 27/00; B32B 3/00; C08J 7/04; B05D 3/04; B05D 3/08; C08J 7/12

(52) U.S. Cl. 428/172; 428/411.1; 427/322; 427/535

(57) ABSTRACT

The invention relates to a plastic profile which can be decorated, comprising a profiled substrate as the main body of the plastic profile, and a method for the production thereof. In order to ensure reliable subsequent decorative coating of the plastic profile over a run even in the event of a longer time interval between substrate manufacturing and decorative coating, according to the invention, a functional layer which at least sectionally covers the substrate is provided, which may subsequently have a decorative coating applied thereto.

The invention relates to a plastic profile which can be decorated, comprising a profiled substrate as the main body of the plastic profile.

In decorating plastic profiles of this type using printing and lacquering methods, substrates which are freshly produced and/or only have been stored briefly (a few hours to a few days) are frequently used. Upon longer storage over weeks and months, as a function of the substrate and the decoration method, problems occur during subsequent coating because of environmental influences and aging phenomena. For example, shrinking effects, subsequent crystallization, oxidation phenomena, moisture absorption, static charge, or contamination of the surfaces by dust, oil, and other media are decisive.

Furthermore, processing-related variations of the surface properties, which are critical to decoration, may occur during the production process of the plastic profiles. This may have the result that the reproducibility of the coating results is negatively influenced in regard to the application flow, the adhesion of the color tone, the degree of gloss, and the surface texture, and reliable coating over a run of the substrates is not provided for the reasons cited. In the plastic profile according to an embodiment, surface properties such as surface structure, surface smoothness/roughness, porosity, penetration capability, gloss, color tone, surface tension, electrical conductivity, etc may vary due to variations in the raw materials used and their preparation and due to variation of the processing parameters during longer production times and/or between various manufacturing batches.

The cited influences make the reproducibility of a decorative coating more difficult with increasing time interval from the manufacturing of the substrate.

The invention is based on the object of providing a plastic profile which can be decorated, which allows reliable reproducibility over a run of the decorative coating even in the event of a longer time interval between the substrate manufacturing and a decorative coating.

To achieve this object, the invention provides the plastic profile which can be decorated according to claim 1, comprising: a profiled substrate as the main body of the plastic profile, and a functional layer which at least sectionally covers the substrate, which subsequently has a decorative coating applied, and a color absorption capability and/or color adhesiveness of the functional layer being set by a proportion of fillers and/or additives contained in the functional layer. The functional layer is not itself subject to the cited disadvantageous influences on the ability to decorate plastic surfaces, so that the decorative coating is reliably reproducible over a run in spite of a time interval from the substrate manufacturing. As a result thereof, the pre-coated plastic profile may be stored or sent to a processor until the following decoration process. The proportion of the fillers and/or additives influence is the wetting ability and/or absorbency of the functional layer, so that an optimum coating is ensured depending on the embodiment of the selected decoration.

In a preferred embodiment of the invention, the decorative coating can adhere on the functional layer and/or is at least partially absorbable in the functional layer. The functional layer forms an adhesive base for the decorative coating and/or a type of “sponge” for absorbing color pigments or other decorative particles of the decorative coating. The functional layer thus ensures an optimum color application and/or an optimum color intercalation, without complex pretreatment measures being necessary for the subsequent decorative coating.

In a further preferred embodiment of the invention, the functional layer comprises:
approximately 10 to 30 wt.-% binder, preferably PVC copolymer;
approximately 10 to 40 wt.-% colorant, preferably pigments or other dyes; and
approximately 40 to 80 wt.-% solvent, preferably organic solvent, preferably based on esters and/or ketones.

The adhesion of the layered construction is influenced by the binder used. The wetting and the absorbency of the functional layer are set via fillers and additives. A coloration of the functional layer is performed via the colorant, preferably pigments and dyes, and is used for reproducibly providing a constant basic color tone for the subsequent decoration. The cited composition ratio has proven to be particularly favorable.

In a further preferred embodiment of the invention, the functional layer also comprises:
approximately 1 to 15 wt.-% adhesive resin, preferably based on polyester; and/or
approximately 0.5 to 2 wt.-% wax, preferably micronized polyethylene wax; and/or
approximately 0.5 to 3 wt.-% silicic acid, preferably post-treated pyrogenic silicic acid; and/or
approximately 0.1 to 1 wt.-% anti-foaming agent.

This composition ratio has proven to be particularly advantageous in the event of a subsequent decorative coating in the inkjet method.

The binder may also be advantageously selected from polyacrylates, polymethacrylates, polyvinyl butyral, polyurethanes, polyesters, polyvinyl acetate, and mixtures and/or copolymers of the cited binder classes.

In a further preferred embodiment of the invention, the plastic profile has priming between the substrate and the functional layer. For this priming, suitable adhesive promoters, preferably based on solvents or water and/or UV-curing are applied to the plastic substrate, preferably in the rolling method or by spray application. The priming improves the adhesion of the functional layer on the substrate and is selected as a function of the plastic of the substrate.

In a further preferred embodiment of the invention, the priming is a water-based or radiation-curable priming.

In a further preferred embodiment of the invention, the priming comprises:
approximately 25 to 28 wt.-% binder, preferably adhesive resin, preferably based on a polyester polyol;
approximately 1.5 to 2.5 wt.-% filler, preferably inorganic filler, preferably pyrogenic silicic acid; and
approximately 60 to 70 wt.-% solvent, preferably organic solvent, more preferably based on ester and/or ketone (e.g., ethyl acetate, cyclohexanone, etc.).

In a further preferred embodiment of the invention, the priming also comprises:
3 to 5 wt.-% of a polyisocyanate.

In a further preferred embodiment of the invention, the substrate is physically treated, preferably on a surface covered by the functional layer. This improves the adhesion of adjoining layers on the substrate.

In a further preferred embodiment of the invention, the functional layer is physically treated. This improves the adhesion of the decorative coating on the functional layer and/or its absorption in the functional layer.

In a further preferred embodiment of the invention, the functional layer has a surface energy of 40 to 55 mN/m, preferably 47 to 52 mN/m. This promotes the quality of the wetting and adhesion of the decorative coating on the functional layer and the achievement of a good ink application flow with high surface coverage and color saturation. The activation of the functional layer using physical pretreatment is preferably performed surely before the subsequent decoration.

In a further preferred embodiment of the invention, the plastic profile is implemented as an edge strip or as an angled profile. Edge strips and/or angled profiles are typically tailored to matching furniture body parts in regard to the decoration, so that the invention having the effect of the subsequent decorative coating of plastic profiles which is reliable over a run is particularly suitable for this purpose.

A further aspect of the invention relates to a method for producing a plastic profile which can be decorated, comprising the following steps:
a) providing a profiled substrate as the main body of the plastic profile;
b) physically treating the substrate to increase the surface energy of the substrate;
c) applying priming to the substrate; and
d) applying a functional layer to the substrate, which has priming applied, the functional layer subsequently being able to have a decorative coating applied.

In a further preferred embodiment of the method according to the invention, step a) comprises the extrusion of the profiled substrate. The extrusion method allows a particularly cost-effective production of the profiled substrate.

In a further preferred embodiment of the method according to the invention, step b) comprises a corona treatment, preferably using low-frequency/high-frequency corona, flaming, plasma treatment, fluorination, silicating, preferably flame pyrolysis of silanes, or a combination thereof. The surface energy of the substrate may easily be increased to greater than 40 mN/m using the cited measures.

In a further preferred embodiment of the method according to the invention, step c) comprises: the application of the priming by spraying, roller application, pouring, flooding, preferably using an application weight of 5 to 20 g/m² wet film thickness. This measure encourages the adhesion of adjoining layers on the substrate surface.

In a further preferred embodiment of the method according to the invention, step d) comprises: the application of the functional layer by spraying, roller application, pouring, or flooding, preferably using an application weight of the functional layer as a function of the requirements between 1 and 100 g/m² wet film thickness, preferably by multiple coats at low application weight. These measures improve the fusion of the functional layer to and/or on the priming and/or the substrate.

In a further preferred embodiment of the method according to the invention, the method also comprises:
e) physically treating the functional layer to increase the surface energy of the functional layer.

In a further preferred embodiment of the method according to the invention, step e) comprises a corona treatment, preferably using low-frequency/high-frequency corona, flaming, plasma treatment, fluorination, silicating, preferably flame pyrolysis of silanes, or a combination thereof. The surface energy of the substrate may easily be increased to greater than 47 mN/m using the cited measures.

A further preferred aspect of the invention relates to a decorated edge strip, comprising: a profiled substrate as the main body, a functional layer which at least sectionally covers the substrate, the functional layer subsequently having a decorative coating applied.

A preferred exemplary embodiments and features of the cited invention are described hereafter with reference to the appended drawings.

### BRIEF DESCRIPTION OF THE DRAWINGS

FIG. 1 schematically shows a method and/or a device for producing a plastic profile which can be decorated according to the invention.

FIG. 2 shows a section II-II of a profiled substrate from FIG. 1.

FIG. 3 shows a section III-III of a physically pretreated, profiled substrate from FIG. 1.

FIG. 4 shows a section IV-IV of a physically pretreated substrate, which is provided with priming, from FIG. 1.

FIG. 5 shows a section V-V of a physically pretreated substrate, which is provided with the functional layer and the priming, from FIG. 1.

FIG. 6 schematically shows a method and/or a device for the subsequent decorative coating of the plastic profile which can be decorated according to the invention.

FIG. 7 shows a section VII-VII of the plastic profile according to the invention from FIG. 6.

FIG. 8 shows a section VIII-VIII of the plastic profile according to the invention having physically treated functional layer from FIG. 6.

FIG. 9 shows a section VIIII-VIIII of the plastic profile, which subsequently has a decorative coating applied, having physically treated functional layer from FIG. 6.

### DETAILED DESCRIPTION OF THE PREFERRED EXEMPLARY EMBODIMENTS OF THE INVENTION

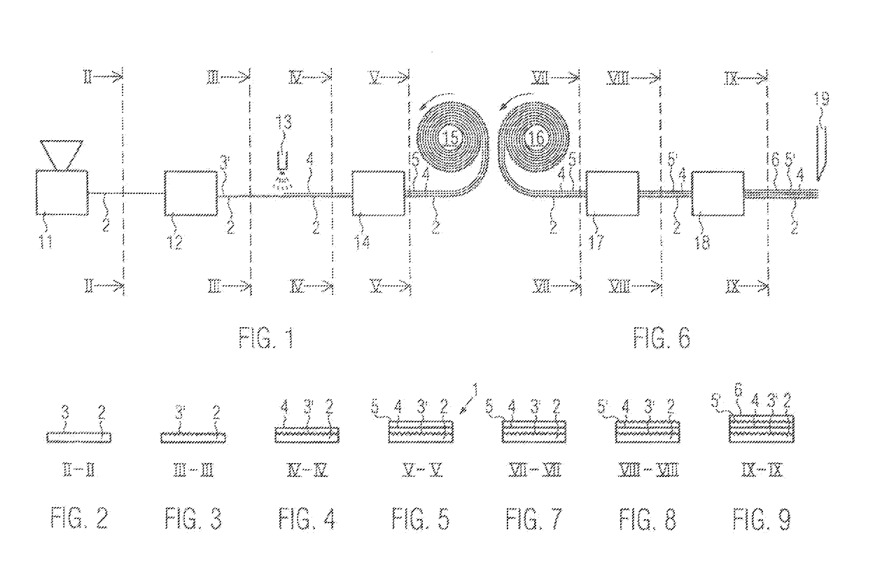

The invention described hereafter with reference to FIGS. 1 through 9 relates to a plastic profile 1, which can be decorated, comprising a profiled substrate as the main body of the plastic profile I and a functional layer 5, which at least sectionally covers the substrate 2 and which may subsequently have a decorative coating 6 applied.

The construction of a plastic profile 1 according to the invention is shown on the basis of the sectional illustration V-V of FIG. 5. The physical pretreatment of the substrate 2 and the application of a priming 4 are not absolutely necessary. These measures may be selected in order to achieve a better bonding of the substrate 2 to the functional layer 5 for specific plastics of the substrate 2.

The decorative coating 6 (e.g., color pigments, decorative particles, etc.) can adhere on the functional layer 5 and/or can be at least sectionally absorbed in the functional layer 5. For better adhesion of the decorative coating 6 on the functional layer 5, the functional layer 5 preferably has a physically pretreated surface 5′. The intercalation of fillers and/or additives in the functional layer 5 influences the wetting ability and/or absorbency of the functional layer 5.

A color print and/or a color lacquering are preferably provided as the decorative coating 6. The color print is preferably applied via printing rollers or applied without contact, for example, in the event of inkjet printing.

The functional layer 5 preferably has the following composition:
approximately 10 to 20 wt.-% binder, preferably PVC copolymer;
approximately 1 to 15 wt.-% adhesive resin, preferably based on polyester;
approximately 10 to 40 wt.-% colorant, preferably pigments or other dyes;
approximately 0.5 to 2 wt.-% wax, preferably micronized polyethylene wax;
approximately 0.5 to 3 wt.-% silicic acid, preferably post-treated pyrogenic silicic acid;
approximately 0.1 to 1 wt.-% anti-foaming agent; and
approximately 40 to 80 wt.-% solvent, preferably organic solvent, more preferably based on esters and/or ketones.

In order to improve the adhesion of the functional layer 5 on the substrate 2, the plastic profile 1 may have a primer 4 between the substrate 2 and the functional layer 5. The primer 4 preferably has the following composition:
approximately 25 to 28 wt.-% binder, preferably adhesive resin, more preferably based on a polyester polyol;
approximately 1.5 to 2.5 wt.-% filler, preferably inorganic filler, more preferably pyrogenic silicic acid;
approximately 3 to 5 wt.-% polyisocyanate; and
approximately 60 to 70 wt.-% solvent, preferably organic solvent, more preferably based on ester and/or ketone.

The use of a water-based primer (cross-linkable polyurethane dispersion) or a radiation-curing primer (e.g., radically and/or cationically curing UV primer) is alternatively also conceivable.

In order to improve the adhesion of the primer 4 on the substrate 2, the profiled substrate 2 may be physically treated, preferably on a surface 3 covered by the functional layer 5. The surface energy of the substrate is increased to greater than 40 mN/m by the physical treatment.

In order to improve the adhesion of the decorative layer 6 on the functional layer 5, the functional layer 5 may be physically treated. The physically treated functional layer preferably has a surface energy of 40 to 55 mN/m, more preferably 47 to 52 mN/m.

In a particularly preferred embodiment of the invention, the plastic profile 1 is implemented as an edge strip or as an angled profile.

The method according to the invention for producing the plastic profile 1 which can be decorated according to the invention is described hereafter with reference to FIGS. 1 through 5.

The method according to the invention for producing the plastic profile 1 which can be decorated comprises the following steps:
a) providing a profiled substrate 2 as the main body of the plastic profile 1;
b) physically treating the substrate 1 to increase the surface energy of the substrate 2;
c) applying a primer 4 to the substrate 2;
d) applying a functional layer 5 to the substrate 1, onto which the primer 4 is applied, the functional layer 5 subsequently being able to have a decorative coating 6 applied.

FIG. 1 schematically shows a device and/or a method for producing the plastic profile 1 which can be decorated according to the invention.

Step a) comprises the provision of a profiled substrate using a provision apparatus 12. An extruder is preferably provided as the provision apparatus 11, the profiled substrate 2 being extruded. The cross-section of the substrate 2 after the execution of step a) is schematically shown in section II-II of FIG. 2. Other cross-sectional profiles of the substrate 2 may also be executed in addition to the rectangular cross-sectional profile.

Step b) comprises a physical pretreatment of the substrate 2, which is necessary in particular for low-energy surfaces such as polyolefins. The functional layer 5 may also be applied directly to the substrate 2 without physical pretreatment of the substrate 2. The surface treatment, which is recommended for specific low-energy surfaces for reasons of adhesion, may be performed via a corona treatment, preferably using low-frequency/high-frequency corona, flaming, plasma treatment, fluorination, silicating, preferably flame pyrolysis of silanes, or a combination thereof. The goal of step b) is to increase the surface energy of the substrate to greater than 40 mN/m. Step b) is performed in an apparatus 12 for the physical pretreatment of the substrate 2.

A surface 3 of the substrate which is to be covered using the functional layer 5 is processed in the scope of the cited measures. The cross-section of the substrate 2 having physically pretreated substrate surface 3′, after execution of step b), is shown in section III-III of FIG. 3.

Step c) comprises the priming of the physically pretreated substrate surface 3′. Like step b), step c) is not absolutely necessary to produce the plastic profile 1 which can be decorated according to the invention. The priming of the substrate surface 3′ is only required for low-energy surfaces such as polyolefins. For critical substrates of this type, in addition to the physical pretreatment according to step b), the substrate may also be equipped with a printing primer, such as an adhesion promoter or a pre-coat. The application of the priming and/or the primer 4 is performed in a suitable apparatus 13 (symbolically shown in FIG. 1) by spraying, roller application, pouring, flooding, etc. using an application weight of the primer 4, depending on the use, between 1 and 50 g/m² wet film thickness. The primer 4 preferably has the above-mentioned composition. The cross-section of the substrate 2 having the primer 4 applied on the physically pretreated surface 3′ is shown in section IV-IV of FIG. 4.

Step d) comprises the application of the functional layer 5 on the substrate 2 and/or on the primer 4. The functional layer 5 forms the adhesive base for the later decorative coating 6 and preferably has the above-mentioned composition. The adhesion of the layered construction is influenced by the binder used. The wetting and the absorbency of the functional layer 5 are set via fillers and additives. Coloration of the functional layer 5 occurs via typical colorants, such as pigments and other dyes, and is used for reproducibly providing a constant basic color tone for the subsequent decoration. The application of the functional layer 5 may be performed by spraying, roller application, pouring, flooding, etc. The application weight of the functional layer 5 is between 1 and 100 g/m² wet film thickness as a function of the requirements. The total application weight may also be produced by multiple coats each having low application weights. Step d) is performed in a suitable apparatus for applying the functional layer 5. The state of the substrate 2 having physically pretreated surface 3′, applied primer 4, and applied functional layer 5 after completed step d) is illustrated in section V-V of FIG. 5.

After the application of the functional layer 5 on the substrate 2 and/or the priming 4, the plastic profile 1 which can be decorated is finished and is prepared for storage or transport. The plastic profile 1 which can be decorated is preferably stored onto a storage apparatus, e.g., rolled onto a storage spool 15.

A method for the subsequent decorative coating of the plastic profile 1 which can be decorated according to the invention is described hereafter with reference to FIGS. 6 through 9.

FIG. 6 schematically shows a device and/or a method for the subsequent decorative coating of the plastic profile 1 which can be decorated according to the invention.

For the decorative coating, the plastic profile 1 which can be decorated according to the invention is provided by a provision apparatus 16. For example, the plastic profile 1 is unwound from a storage coil 16 and supplied to the following method steps and/or devices. The cross-section of the plastic profile 1, comprising the substrate 2 having physically treated surface 3′, the primer 4, and the functional layer 5, after execution of step d) and before execution of step e), is illustrated in section VII-VII of FIG. 7. As noted, steps b) and c) are not absolutely necessary for producing the plastic profile 1 according to the invention. Accordingly, the plastic profile 1 according to the invention does not necessarily comprise a physically treated surface 3′ or a primer 4, as shown in FIG. 5. In such a case, the functional layer 5 is bonded directly to the substrate 2.

Step e) comprises the physical treatment of the functional layer 5 before the subsequent decoration of the plastic profile 1 in an apparatus 17 suitable for this purpose. For an optimum adhesion of the decorative coating 6 on the functional layer 5 and to achieve a good ink application flow having high surface coverage and color saturation, an activation of the functional layer 5 using physical pretreatment in a suitable apparatus 17 is performed shortly before the subsequent decoration of the plastic profile 1. The activation of the functional layer 5 is preferably performed by corona treatment, preferably using low-frequency/high-frequency corona, flaming, plasma treatment, fluorination, silicating, preferably flame pyrolysis of silanes, or a combination thereof. In step e), an increase of the surface energy of the functional layer from an average of 41 to 43 mN/m before the activation to 47 to 52 mN/m after the activation and/or treatment is achieved. The surface energy of the functional layer 5 is determined via contact angle measurements. The cross-section of the plastic profile 1 after execution of step e) is illustrated in section VIII-VIII of FIG. 2.

After execution of step e), the functional layer 5 has a roughened and/or activated surface 5′.

Step f) comprises the application of the decorative coating 6 to the functional layer 5 in a suitable apparatus 18 for applying the decorative coating 6 on the functional layer 5. The application of the decorative coating 6 is preferably performed by roller application or without contact in the inkjet method. The state of the decoratively-coated plastic profile 1 after execution of step f) is illustrated in section VIIII-VIIII of FIG. 9.

The plastic profile 1 according to the invention is preferably used as an angled profile or edge strip for the decoration of furniture parts or the like.

What is claimed is:

1. A plastic profile (1) which can be decorated, comprising:
a profiled substrate (2) as the main body of the plastic profile (1) and
a functional layer (5) which at least sectionally covers the substrate (2),
wherein the functional layer (5) subsequently has a decorative coating (6) applied, and a color absorption capability and/or a color adhesion capability of the functional layer (5) is set by a proportion of fillers and/or additives contained in the functional layer (5).

2. The plastic profile (1) according to claim 1, wherein the decorative coating (6) can adhere on the functional layer (5) and/or can be absorbed in the functional layer (5).

3. The plastic profile (1) according to claim 1, wherein a color print and/or a color lacquering is provided as the decorative coating (6).

4. The plastic profile (1) according to claim 1, wherein the plastic profile (1) has a primer (4) between the substrate (2) and the functional layer (5).

5. The plastic profile (1) according to claim 4, wherein the primer is a water-based or radiation-curing primer.

6. The plastic profile (1) according to claim 1, wherein the functional layer has a surface energy of 40 to 55 mN/m, preferably 47 to 52 mN/m.

7. The plastic profile (1) according to claim 1, wherein the plastic profile (1) is implemented as an edge strip or as an angled profile.

8. A method for producing a plastic profile (1) which can be decorated, comprising the following steps:
a) providing a profiled substrate (2) as the main body of the plastic profile (1), characterized by
b) physically treating the substrate (1) to increase the surface energy of the substrate (1);
c) applying a primer (4) to the substrate (1); and
d) applying a functional layer (5) to the substrate (1), to which the primer (4) was applied (1), the functional layer (5) subsequently having a decorative coating (6) applied.

9. The method according to claim 8, wherein step a) comprises: extruding the profiled substrate (2) as the main body of the plastic profile (1).

10. The method according to claim 8, wherein step b) comprises: a corona treatment of the substrate (1), preferably using low-frequency/high-frequency corona, flaming, plasma treatment, fluorination, silicating, preferably flame pyrolysis of silanes, or a combination thereof.

11. The method according to claim 8, wherein step c) comprises: applying the primer by spraying, roller application, pouring, flooding, etc., preferably having a wet film thickness of 1 to 50 g/m².

12. The method according to claim 8, wherein step d) comprises: applying the functional layer by spraying, roller application, pouring, or flooding, preferably having a wet film thickness between 1 and 100 g/m², preferably in multiple coats.

13. The method according to claim 8, wherein the method also comprises:
e) physically treating the functional layer (5) to increase the surface energy of the functional layer (5), preferably to 47 to 52 mN/m.

14. The method according to claim 13, wherein step e) comprises: corona treatment, preferably using low-frequency/high-frequency corona, flaming, plasma treatment, fluorination, silicating, preferably flame pyrolysis of silanes, or a combination thereof.
